(19) United States
(12) Patent Application Publication
(10) Pub. No.: US 2025/0308763 A1
(43) Pub. Date: Oct. 2, 2025

(54) COIL DEVICE

(71) Applicant: TDK Corporation, Tokyo (JP)

(72) Inventors: Kosuke KUNITSUKA, Tokyo (JP); Taishi KITAMURA, Tokyo (JP)

(73) Assignee: TDK Corporation, Tokyo (JP)

(21) Appl. No.: 19/089,481

(22) Filed: Mar. 25, 2025

(30) Foreign Application Priority Data
Mar. 28, 2024 (JP) 2024-055013

(51) Int. Cl. H01F 27/34; H01F 3/10; H01F 5/04; H01F 17/04; H01F 27/28; H01F 27/29

(52) U.S. Cl. CPC H01F 27/34; H01F 3/10; H01F 5/04; H01F 17/04; H01F 27/2828; H01F 27/292

(57) ABSTRACT

A coil device includes a core including a winding core portion and a flange portion formed at an end portion of winding core portion in an axial direction; a plate-shaped core attached to core; a first wire wound around winding core portion; a second wire wound around winding core portion to form a pair with first wire; a first terminal electrode provided on at least a mounting surface of the flange portion; and a second terminal electrode provided on at least the mounting surface, and spaced apart from first terminal electrode. The flange portion includes a recess recessed from mounting surface between first terminal electrode and second terminal electrode. A bottom surface of recess is flush with an outer peripheral surface of the winding core portion. The pair of the first wire and the second wire have a plurality of turns spaced apart from each other along the axial direction.

### BACKGROUND OF THE INVENTION

### 1. Field of the Invention

The present disclosure relates to a coil device.

### 2. Description of the Related Art

Patent Document 1 discloses a technology related to a coil device applicable to a common mode filter. The coil device of Patent Document 1 is a surface-mount electronic component, and includes a drum core and a plate-shaped core attached to the drum core. The drum core includes a winding core portion and flange portions formed at end portions of the winding core portion in an axial direction. A first wire and a second wire are wound around the winding core portion. A first terminal electrode and a second terminal electrode are provided on mounting surfaces of the flange portions so as to be spaced apart from each other. An end portion of the first wire is connected to the first terminal electrode, and an end portion of the second wire is connected to the second terminal electrode. The plate-shaped core is attached to surfaces of the flange portions opposite to the mounting surfaces.

In the coil device of Patent Document 1, ideally, magnetic flux generated from the first wire and the second wire passes through an annular path connecting the winding core portion, the flange portion at one end of the winding core portion in the axial direction, the plate-shaped core, and the flange portion at the other end of the winding core portion in the axial direction in the shortest distance.

### CITATION LIST

### Patent Document

Patent Document 1: JP 2014-99587 A

### SUMMARY OF THE INVENTION

However, in reality, a part of the magnetic flux generated from the first wire and the second wire does not pass through the ideal path described above, but diffuses to a position deviating from the ideal path. A part of the diffused magnetic flux, as leakage magnetic flux, can be a cause of an increase in the insertion loss of the coil device.

The present disclosure provides a coil device capable of reducing insertion loss caused by leakage magnetic flux.

A coil device of the present disclosure includes a core including a winding core portion and a flange portion formed at an end portion of the winding core portion in an axial direction; a plate-shaped core attached to the core; a first wire wound around the winding core portion; a second wire wound around the winding core portion so as to form a pair with the first wire; a first terminal electrode provided on at least a mounting surface of the flange portion; and a second terminal electrode provided on at least the mounting surface, and spaced apart from the first terminal electrode. The flange portion includes a recess recessed from the mounting surface between the first terminal electrode and the second terminal electrode. A bottom surface of the recess is flush with an outer peripheral surface of the winding core portion. The pair of the first wire and the second wire have a plurality of turns spaced apart from each other along the axial direction.

In the coil device of the present disclosure, the flange portion includes the recess recessed from the mounting surface between the first terminal electrode and the second terminal electrode. Therefore, at least a part of a path that diffuses magnetic flux toward a mounting surface side of the flange portion is blocked by the recess, so that the magnetic flux is less likely to diffuse to the mounting surface side of the flange portion. Accordingly, leakage magnetic flux is reduced, and the amount of magnetic flux passing through a path connecting the winding core portion, the flange portion, and the plate-shaped core in the shortest distance is increased. Therefore, the insertion loss of the coil device caused by leakage magnetic flux can be reduced. In addition, the bottom surface of the recess is flush with the outer peripheral surface of the winding core portion. Therefore, no step is formed between the bottom surface of the recess and the outer peripheral surface of the winding core portion, and the concentration of magnetic flux on the step, which is a cause of insertion loss, can be avoided.

In addition, the second wire is wound around the winding core portion so as to form a pair with the first wire. Furthermore, the pair of the first wire and the second wire have the plurality of turns spaced apart from each other along the axial direction. Therefore, the coupling between the first wire and the second wire is improved, and leakage magnetic flux is reduced. In addition, the stray capacitance between the turns adjacent to each other along the axial direction is reduced. Accordingly, the insertion loss of the coil device caused by leakage magnetic flux can be further reduced.

The flange portion may have an inner end surface connected to the winding core portion, and an outer end surface opposite to the inner end surface along the axial direction. The recess may extend from the inner end surface to the outer end surface along the axial direction.

The first wire may include a first lead-out portion led out from the winding core portion toward the flange portion. The second wire may include a second lead-out portion led out from the winding core portion toward the flange portion. The first lead-out portion may be led out from the winding core portion to the first terminal electrode while being in contact with the core. The second lead-out portion may be led out from the winding core portion to the second terminal electrode while being in contact with the core.

The first lead-out portion may include a first straight portion passing through the recess along the axial direction, and a first rising portion that extends along a direction perpendicular to the axial direction in a plan view, and that rises from the bottom surface of the recess toward the mounting surface. The second lead-out portion may include a second straight portion passing through the recess along the axial direction, and a second rising portion that extends along the direction perpendicular to the axial direction in a planar view, and that rises from the bottom surface of the recess toward the mounting surface.

The first lead-out portion may include a straight portion passing through the recess along the axial direction, and a first rising portion that extends along a direction perpendicular to the axial direction in a plan view, and that rises from the bottom surface of the recess toward the first terminal electrode. The second lead-out portion may include an inclined portion passing through the recess obliquely with respect to the axial direction, and a second rising portion that extends along the direction perpendicular to the axial direction in a plan view, and that rises from the bottom surface of the recess toward the second terminal electrode.

The flange portion may have a first inclined surface and a second inclined surface. The first inclined surface may be inclined from the bottom surface of the recess toward the mounting surface on one side in a direction perpendicular to the axial direction in a plan view. The second inclined surface may be inclined from the bottom surface of the recess toward the mounting surface on the other side in the direction perpendicular to the axial direction in a plan view.

The flange portion may have a first inner wall surface and a second inner wall surface. The first inner wall surface may rise perpendicularly from the bottom surface of the recess toward the mounting surface on the one side in the direction perpendicular to the axial direction in a plan view. The second inner wall surface may rise perpendicularly from the bottom surface of the recess toward the mounting surface on the other side in the direction perpendicular to the axial direction in a plan view. In the axial direction, the first inner wall surface may be located on an inner side of the flange portion, and the first inclined surface may be located on an outer side of the flange portion. In the axial direction, the second inner wall surface may be located on the inner side of the flange portion, and the second inclined surface may be located on the outer side of the flange portion.

The flange portion may have an inner end surface connected to the winding core portion, and an outer end surface opposite to the inner end surface along the axial direction. A first connection position between the first lead-out portion and the first terminal electrode may be closer to the inner end surface than to the outer end surface. A second connection position between the second lead-out portion and the second terminal electrode may be closer to the inner end surface than to the outer end surface.

The mounting surface may include a first region where the first terminal electrode is provided, and a second region where the second terminal electrode is provided. The recess may be located between the first region and the second region. The first region may include a first exposed portion located between the first terminal electrode and the recess. The second region may include a second exposed portion located between the second terminal electrode and the recess. The mounting surface may be exposed at the first exposed portion and the second exposed portion.

### BRIEF DESCRIPTION OF THE DRAWINGS

FIG. 1A is a perspective view of a coil device of a first embodiment;

FIG. 1B is a plan view of the coil device illustrated in FIG. 1A;

FIG. 1C is a side view of the coil device illustrated in FIG. 1A when viewed in an X-axis direction;

FIG. 1D is a side view of the coil device illustrated in FIG. 1A when viewed in a Y-axis direction;

FIG. 2 is a perspective view of a core of the coil device illustrated in FIG. 1A;

FIG. 3A is a graph illustrating frequency characteristics of leakage inductance of the coil device illustrated in FIG. 1A;

FIG. 3B is a graph showing frequency characteristics of insertion loss of the coil device illustrated in FIG. 1A;

FIG. 4A is a perspective view of a coil device of a second embodiment;

FIG. 4B is a plan view of the coil device illustrated in FIG. 4A;

FIG. 5 is a plan view of a coil device of a third embodiment;

FIG. 6 is a perspective view of a coil device of a fourth embodiment; and

FIG. 7 is a plan view of a modification example of the coil device of the second embodiment.

### DETAILED DESCRIPTION OF THE PREFERRED EMBODIMENTS

Hereinafter, embodiments of the present disclosure will be described with reference to the drawings. The illustrated contents are merely provided schematically and exemplarily for the understanding of the present disclosure, and the appearance, dimensional ratios, or the like can be different from the actual product. In addition, the present disclosure is not limited to the following embodiments.

### First Embodiment

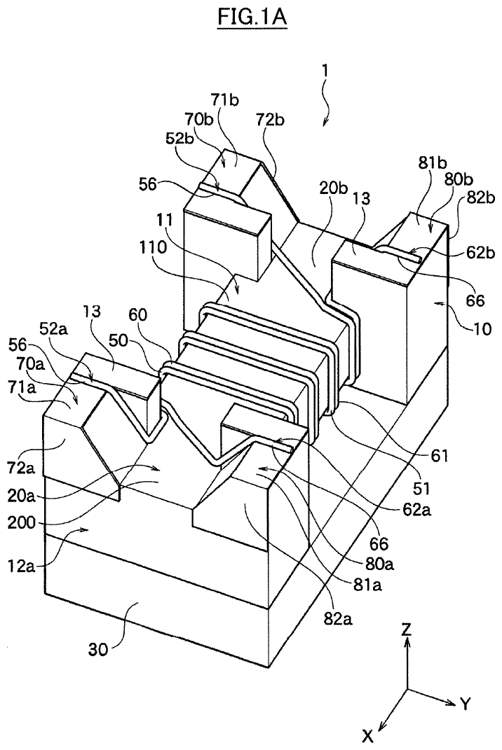

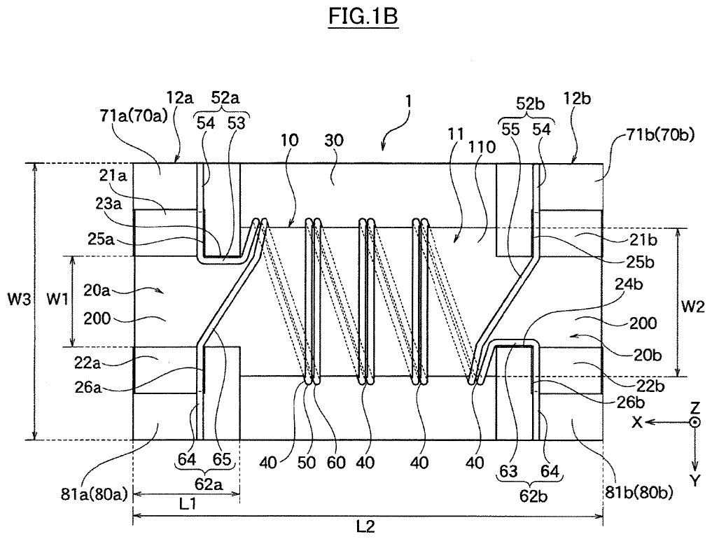

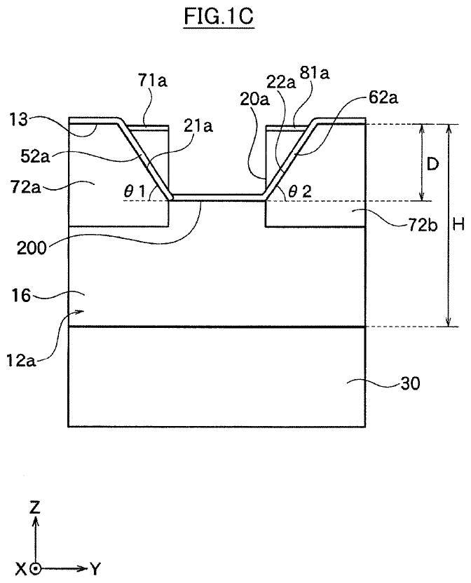

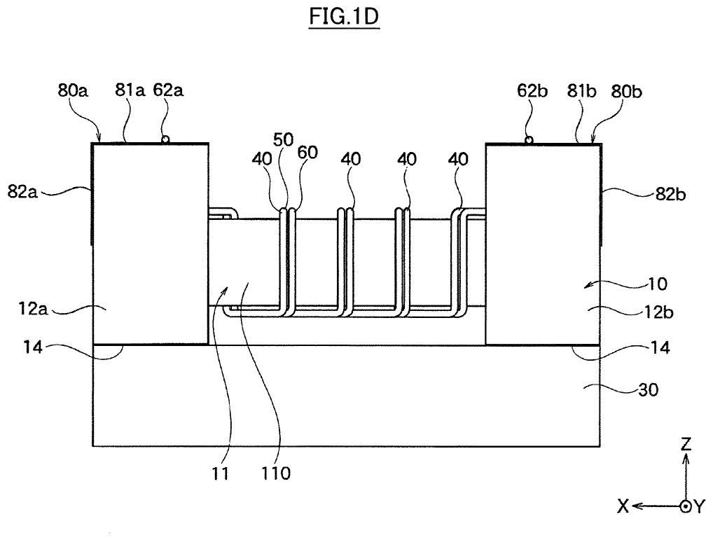

As illustrated in FIG. 1A, a coil device 1 of the first embodiment is a surface-mount electronic component, and functions as a common mode filter, a pulse transformer, a balun transformer, and the like. The coil device 1 is mounted on, for example, a signal circuit of a communication device or the like. The coil device 1 includes a core 10, a plate-shaped core 30, a first wire 50, a second wire 60, terminal electrodes 70a and 70b, and terminal electrodes 80a and 80b.

Each of the first wire 50 and the second wire 60 is, for example, an insulated wire, and includes a conductive core wire covered with an insulating coating. The first wire 50 and the second wire 60 are known winding wires such as polyamideimide copper wire (AIW), polyurethane copper wire (UEW) or polyester copper wire (PEW). The first wire 50 and the second wire 60 are round wires, but may be square wires, stranded wires, Litz wires, braided wires, or the like. The material constituting the first wire 50 and the second wire 60 is not particularly limited, but is, for example, copper, a copper alloy, silver, or nickel. The diameter of the first wire 50 or the second wire 60 is not particularly limited, but is, for example, 10 to 100 μm. The diameter of the first wire 50 is equal to the diameter of the second wire 60, but may be different. The coating is stripped at both end portions of the first wire 50 or the second wire 60, so that the conductive core wire is exposed.

The first wire 50 includes a winding portion 51 and lead-out portions 52a and 52b. The winding portion 51 is formed by spirally winding the first wire 50 around an outer peripheral surface 110 of a winding core portion 11.

The lead-out portion 52a is led out from the winding portion 51, and constitutes one end portion of the first wire 50. The lead-out portion 52b is led out from the winding portion 51, and constitutes the other end portion of the first wire 50.

A winding portion 61 is formed by spirally winding the second wire 60 around the outer peripheral surface 110 of the winding core portion 11. The second wire 60 is wound around the outer peripheral surface 110 so as to form a pair with the first wire 50. Namely, the first wire 50 and the second wire 60 are bifilar wound. The first wire 50 and the second wire 60 may be in close contact with each other, or may be spaced apart from each other. A lead-out portion 62a is led out from the winding portion 61, and constitutes one end portion of the second wire 60. A lead-out portion 62b is led out from the winding portion 61, and constitutes the other end portion of the second wire 60.

The core 10 is formed from a material containing a magnetic material and a resin. The magnetic material constituting the core 10 is not particularly limited, but is, for example, ferrite (Ni—Zn ferrite, Mn—Zn ferrite, or the like) or a metallic magnetic material (Fe—Ni alloy, Fe—Si alloy, Fe—Si—Cr alloy, Fe—Co alloy, Fe—Si—Al alloy, amorphous iron, or the like). The resin constituting the core 10 is not particularly limited, but is an epoxy resin, a phenolic resin, a polyester resin, a polyurethane resin, a polyimide resin, or the like. The core 10 may be a sintered body of a metallic magnetic material.

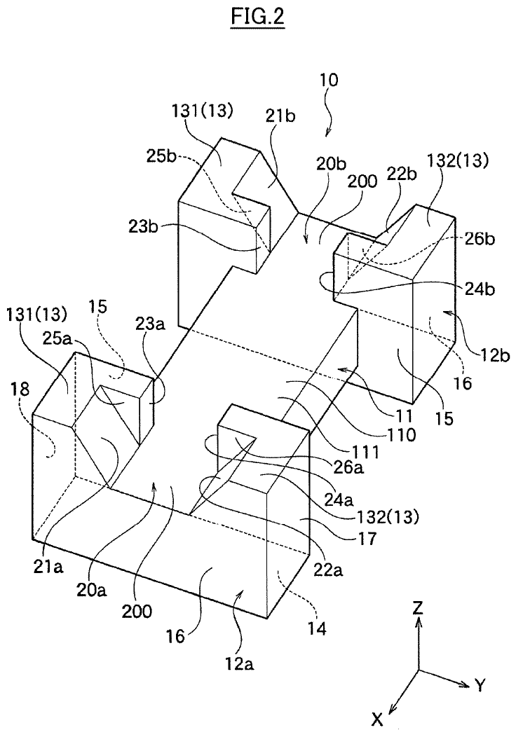

As illustrated in FIG. 2, the core 10 includes the winding core portion 11, a flange portion 12a, and a flange portion 12b. The cross-sectional shape of the winding core portion 11 perpendicular to an axial direction is a rectangular shape, but may be a squares shape, a hexagonal shape, an octagonal shape, or any other polygonal shape. The winding core portion 11 has the outer peripheral surface 110 including a flat surface. The flange portion 12a is formed at one end of the winding core portion 11 in the axial direction, and the flange portion 12b is formed at the other end of the winding core portion 11 in the axial direction.

The flange portion 12a has a mounting surface 13, an attachment surface 14, an inner end surface 15, an outer end surface 16, a first side surface 17, and a second side surface 18. Similarly, the flange portion 12b has the mounting surface 13, the attachment surface 14, the inner end surface 15, the outer end surface 16, the first side surface 17, and the second side surface 18. The shapes of the flange portions 12a and 12b are the same, but may be different.

The mounting surface 13 is a surface facing a mounting substrate (not illustrated). The attachment surface 14 is a surface facing the mounting surface 13. The plate-shaped core 30 (FIG. 1A) is attached to the attachment surface 14. The inner end surface 15 is a surface connected to the winding core portion 11. The outer end surface 16 is a surface facing the inner end surface 15. The first side surface 17 is a surface perpendicular to the attachment surface 14, the inner end surface 15, and the outer end surface 16. The second side surface 18 faces the first side surface 17, and is a surface perpendicular to the attachment surface 14, the inner end surface 15, and the outer end surface 16.

Hereinafter, an axis along a direction in which the inner end surface 15 and the outer end surface 16 face each other is defined as an X-axis. In addition, an axis along a direction in which the first side surface 17 and the second side surface 18 face each other is defined as a Y-axis. In addition, an axis along a direction in which the mounting surface 13 and the attachment surface 14 face each other is defined as a Z-axis. The X-axis is an axis along the axial direction of the winding core portion 11. In addition, the Y-axis is an axis that extends perpendicular to the axial direction of the winding core portion 11 in a plan view.

In the present disclosure, the positive direction side of the Z-axis is defined as “upward” or “upper side”, and the negative direction side of the Z-axis is defined as “downward” or “lower side”. However, the upper side in a Z-axis direction does not necessarily coincide with an upper side in a vertical direction. In addition, the lower side in the Z-axis direction does not necessarily coincide with a lower side in the vertical direction.

In addition, in the present disclosure, “equal” or “same” does not only refer to a concept indicating a state where the physical quantities of a plurality of objects being compared are strictly equal or the same, but the concept of “equal” or “same” also includes a state where an error of ±Δ% (although not particularly limited, for example, Δ=7, 5, or 3) or less occurs between the physical quantities of the plurality of objects being compared.

In addition, in the present disclosure, “parallel” does not only refer to the concept of being strictly parallel, but the concept of “parallel” also includes a state where an error of ±Δθ° (although not particularly limited, for example, Δθ=3) or less occurs with respect to being strictly parallel. In addition, “perpendicular” or “orthogonal” does not only refer to the concept of being strictly perpendicular or orthogonal, but the concept of “perpendicular” or “orthogonal” also includes a state where an error of ±Δθ° (although not particularly limited, for example, Δθ=3) or less occurs with respect to being strictly perpendicular or orthogonal.

Recesses 20a and 20b extend (penetrates) linearly from the inner end surface 15 to the outer end surface 16 along an X-axis direction. As illustrated in FIG. 1A, the recess 20a is recessed downward from the mounting surface 13 of the flange portion 12a between the first terminal electrode 70a (a substrate connecting portion 71a) and the second terminal electrode 80a (a substrate connecting portion 81a). The recess 20b is recessed downward from the mounting surface 13 of the flange portion 12b between the first terminal electrode 70b (a substrate connecting portion 71b) and the second terminal electrode 80b (a substrate connecting portion 81b).

As illustrated in FIG. 2, the mounting surface 13 of the flange portion 12a is divided by the recess 20a into a first region 131 that is a region on one side in a Y-axis direction, and a second region 132 that a region on the other side in the Y-axis direction. The recess 20a is located between the first region 131 and the second region 132 of the flange portion 12a. In addition, the mounting surface 13 of the flange portion 12b is divided by the recess 20b into the first region 131 that is a region on the one side in the Y-axis direction, and the second region 132 that is a region on the other side in the Y-axis direction. The recess 20b is located between the first region 131 and the second region 132 of the flange portion 12b.

As illustrated in FIG. 1B, a width W1 of the recess 20a (similarly for the recess 20b) in the Y-axis direction is narrower than a width W2 of the winding core portion 11 in the Y-axis direction. However, the width W1 of the recess 20a may be equal to the width W2 of the winding core portion 11, or may be larger than the width W2 of the winding core portion 11. From the viewpoint of effectively reducing leakage magnetic flux of the coil device 1, it is preferable that W1>W2 or W1≥W2. On the other hand, from the viewpoint of effectively ensuring the strength of the core 10 (the flange portions 12a and 12b), it is preferable that W1<W2 or W1≤W2.

The width W1 of the recess 20a is constant along the X-axis direction, but may vary. For example, the width W1 of the recess 20a may become narrower (wider) toward one side in the X-axis direction. Alternatively, the recess 20a may include a narrow portion of which the width W1 is relatively narrow, and a wide portion of which the width W1 is relatively wide.

A ratio W1/W3 of the width W1 of the recess 20a (similarly for the recess 20b) in the Y-axis direction to a width W3 of the flange portion 12a in the Y-axis direction is not particularly limited, but is, for example, ⅛≤W1/W3<1 or ¼≤W1/W3<1. By setting the value of W1/W3 in the above-described range, the magnetic flux of the first wire 50 and the second wire 60 is made less likely to diffuse toward a mounting surface 13 side of the flange portion 12a, and is made more likely to pass through an annular path connecting the winding core portion 11, the flange portion 12a, the plate-shaped core 30, and the flange portion 12b in the shortest distance. Accordingly, leakage magnetic flux of the coil device 1 can be reduced.

A length L1 of the recess 20a (similarly for the recess 20b) in the X-axis direction is equal to a length of the flange portion 12a in the X-axis direction. A ratio L1/L2 of the length L1 of the recess 20a in the X-axis direction to a length L2 (total length) of the core 10 in the X-axis direction is not particularly limited, but is, for example, 1/10≤L1/L2<½ or ⅛≤L1/L2≤¼. As described above, leakage magnetic flux of the coil device 1 can be reduced by setting the value of L1/L2 in the above-described range.

In the example illustrated in FIG. 1C, a depth D of the recess 20a (similarly for the recess 20b) is smaller than ½ of a height H of the flange portion 12a, but may be ½ of the height H or may be equal to or more than ½ of the height H. The depth D of the recess 20a corresponds to a length along the Z-axis between the mounting surface 13 of the flange portion 12a and a bottom surface 200 of the recess 20a. In the present embodiment, the length along the Z-axis between the mounting surface 13 of the flange portion 12a and the bottom surface 200 of the recess 20a is equal to a length along the Z-axis between the mounting surface 13 of the flange portion 12a and the outer peripheral surface 110 (here, an upper surface 111 of the outer peripheral surface 110 illustrated in FIG. 2) of the winding core portion 11.

As illustrated in FIG. 2, the bottom surface 200 of the recess 20a is flush with the outer peripheral surface 110 (here, the upper surface 111 of the outer circumferential surface 110) of the winding core portion 11. In addition, the bottom surface 200 of the recess 20b is flush with the outer peripheral surface 110 (here, the upper surface 111) of the winding core portion 11. Namely, the bottom surface 200 and the outer peripheral surface 110 are continuous with each other in a flat (smooth) manner, and no step is formed between the bottom surface 200 and the outer peripheral surface 110. In the present embodiment, a flat surface is continuously formed in a region along the X-axis direction from the outer end surface 16 of the flange portion 12a to the outer end surface 16 of the flange portion 12b (namely, the bottom surface 200 of the recess 20a, the outer peripheral surface 110 of the winding core portion 11, and the bottom surface 200 of the recess 20b). In addition, the height position of the bottom surface 200 and the height position of the outer peripheral surface 110 (here, the upper surface 111) coincide with each other.

Although not particularly limited, the upper surface 111 of the outer peripheral surface 110 is a flat surface parallel to the mounting surface 13. The similar configuration is applied to a lower surface (a surface facing the upper surface 111) of the outer peripheral surface 110. Side surfaces of the outer peripheral surface 110 (surfaces perpendicular to the upper surface 111) are flat surfaces parallel to the first side surface 17 and the second side surface 18. In addition, although not particularly limited, the bottom surfaces 200 of the recesses 20a and 20b are flat surfaces parallel to the mounting surface 13.

The flange portion 12a has a first inclined surface 21a, a second inclined surface 22a, a first inner wall surface 23a, a second inner wall surface 24a, a first protruding surface 25a, and a second protruding surface 26a. These surfaces are located on both sides of the recess 20a in the Y-axis direction. In addition, the flange portion 12b has a first inclined surface 21b, a second inclined surface 22b, a first inner wall surface 23b, a second inner wall surface 24b, a first protruding surface 25b, and a second protruding surface 26b. These surfaces are located on both sides of the recess 20b in the Y-axis direction.

The first inclined surface 21a is inclined (rises obliquely) from the bottom surface 200 of the recess 20a toward the first region 131 of the mounting surface 13 on the one side in the Y-axis direction. In addition, the second inclined surface 22a is inclined (rises obliquely) from the bottom surface 200 of the recess 20a toward the second region 132 of the mounting surface 13 on the other side in the Y-axis direction. In addition, the first inclined surface 21b is inclined (rises obliquely) from the bottom surface 200 of the recess 20b toward the first region 131 of the mounting surface 13 on the one side in the Y-axis direction. In addition, the second inclined surface 22b is inclined (rises obliquely) from the bottom surface 200 of the recess 20b toward the second region 132 of the mounting surface 13 on the other side in the Y-axis direction.

As illustrated in FIG. 1C, an angle θ1 formed by the first inclined surface 21a (similarly for the first inclined surface 21b) with respect to the Y-axis is not particularly limited, but 15° or more and less than 90°. An angle θ2 formed by the second inclined surface 22a (similarly for the second inclined surface 22b) with respect to the Y-axis is not particularly limited, but is 15° or more and less than 90°.

As illustrated in FIG. 2, a part of the first region 131 is cut by the first inclined surface 21a or 21b. Therefore, the shape of the first region 131 is an L-shape in a plan view. In addition, a part of the second region 132 is cut by the second inclined surface 22a or 22b. Therefore, the shape of the second region 132 is an L-shape in a plan view.

The first inner wall surface 23a rises perpendicularly from the bottom surface 200 of the recess 20a toward the first region 131 of the mounting surface 13 on the one side in the Y-axis direction. The second inner wall surface 24a rises perpendicularly from the bottom surface 200 of the recess 20a toward the second region 132 of the mounting surface 13 on the other side in the Y-axis direction. In addition, the first inner wall surface 23b rises perpendicularly from the bottom surface 200 of the recess 20b toward the first region 131 of the mounting surface 13 on the one side in the Y-axis direction. The second inner wall surface 24b rises perpendicularly from the bottom surface 200 of the recess 20b toward the second region 132 of the mounting surface 13 on the other side in the Y-axis direction. The first inner wall surface 23a, the first inner wall surface 23b, the second inner wall surface 24a, and the second inner wall surface 24b are perpendicular to the mounting surface 13.

In the X-axis direction, the first inner wall surface 23a is located on the inner side (on an inner end surface 15 side) of the flange portion 12a, and the first inclined surface 21a is located on the outer side (on an outer end surface 16 side) of the flange portion 12a. In addition, in the X-axis direction, the second inner wall surface 24a is located on an inner side of the flange portion 12a, and the second inclined surface 22a is located on an outer side of the flange portion 12a. In addition, in the X-axis direction, the first inner wall surface 23b is located on an inner side of the flange portion 12b, and the first inclined surface 21b is located on an outer side of the flange portion 12b. In addition, in the X-axis direction, the second inner wall surface 24b is located on the inner side of the flange portion 12b, and the second inclined surface 22b is located on the outer side of the flange portion 12b.

A width of the first inner wall surface 23a (similarly for the first inner wall surface 23b) in the X-axis direction is narrower than a width of the first inclined surface 21a in the X-axis direction, but may be the same as or wider than the width of the first inclined surface 21a in the X-axis direction. A width of the second inner wall surface 24a (similarly for the second inner wall surface 24b) in the X-axis direction is narrower than a width of the second inclined surface 22a in the X-axis direction, but may be the same as or wider than the width of the second inclined surface 22a in the X-axis direction.

The first protruding surface 25a is a surface perpendicular to the first inner wall surface 23a and the first region 131, and extends (protrudes) along a direction perpendicular to the first inclined surface 21a. The second protruding surface 26a is a surface perpendicular to the second inner wall surface 24a and the second region 132, and extends (protrudes) along a direction perpendicular to the second inclined surface 22a. The first protruding surface 25b is a surface perpendicular to the first inner wall surface 23b and the first region 131, and extends (protrudes) along a direction perpendicular to the first inclined surface 21b. The second protruding surface 26b is a surface perpendicular to the second inner wall surface 24b and the second region 132, and extends (protrudes) along a direction perpendicular to the second inclined surface 22b. When viewed in the X-axis direction, the shapes of the first protruding surface 25a, the first protruding surface 25b, the second protruding surface 26a, and the second protruding surface 26b are not particularly limited, but are a triangular shape.

As illustrated in FIGS. 1A and 2, the first terminal electrode 70a is provided on at least the mounting surface 13 (in the present embodiment, the first region 131 and the outer end surface 16) of the flange portion 12a on the one side in the Y-axis direction. In addition, the second terminal electrode 80a is provided on at least the mounting surface 13 (in the present embodiment, the second region 132 and the outer end surface 16) of the flange portion 12a on the other side in the Y-axis direction, and is spaced apart from the first terminal electrode 70a along the Y-axis direction. The shape of the first terminal electrode 70a is the same as the shape of the first region 131, namely, an L-shape, in a plan view. The shape of the second terminal electrode 80a is the same as the shape of the second region 132, namely, an L-shape, in a plan view.

In addition, the first terminal electrode 70b is provided on at least the mounting surface 13 (in the present embodiment, the first region 131 and the outer end surface 16) of the flange portion 12b on the one side in the Y-axis direction. In addition, the second terminal electrode 80b is provided on at least the mounting surface 13 (in the present embodiment, the second region 132 and the outer end surface 16) of the flange portion 12b on the other side in the Y-axis direction, and is spaced apart from the first terminal electrode 70b along the Y-axis direction. The shape of the first terminal electrode 70b is the same as the shape of the first region 131, namely, an L-shape, in a plan view. The shape of the second terminal electrode 80b is the same as the shape of the second region 132, namely, an L-shape, in a plan view.

The first terminal electrodes 70a and 70b include the substrate connecting portion 71a and 71b and side portions 72a and 72b, respectively. In addition, the second terminal electrodes 80a and 80b include the substrate connecting portions 81a and 81b and side portions 82a and 82b, respectively. The substrate connecting portions 71a, 71b, 81a, and 81b are portions that are connected to a land pattern of the mounting substrate (not illustrated), and are connected to the land pattern by, for example, solder or a conductive adhesive.

As illustrated in FIGS. 1A and 2, the substrate connecting portions 71a or 71b is formed over the entirety of the first region 131, but may be formed in a part of the first region 131. In addition, the substrate connecting portion 71a may be formed on the first inclined surface 21a in addition to the first region 131. In addition, the substrate connecting portion 71b may be formed on the first inclined surface 21b in addition to the first region 131. The substrate connecting portions 81a or 81b is formed over the entirety of the second region 132, but may be formed in a part of the second region 132. In addition, the substrate connecting portion 81a may be formed on the second inclined surface 22a in addition to the second region 132. In addition, the substrate connecting portion 81b may be formed on the second inclined surface 22b in addition to the second region 132.

The side portions 72a and 82a are formed on the outer end surfaces 16 of the flange portion 12a. The side portions 72b and 82b are formed on the outer end surfaces 16 of the flange portion 12b. The side portion 72a is continuous with the substrate connecting portion 71a, the side portion 72b is continuous with the substrate connecting portion 71b, the side portion 82a is continuous with the substrate connecting portion 81a, and the side portion 82b is continuous with the substrate connecting portion 81b. Fillets of solder, a conductive adhesive or the like are formed on the side portions 72a, 72b, 82a, and 82b.

The first terminal electrode 70a (similarly for the first terminal electrode 70b, the second terminal electrode 80a, and the second terminal electrode 80b) is composed of, for example, a laminated electrode film including a base electrode film and a plating film formed on the foundation electrode film. A conductive paste film containing a metal such as Sn, Ag, Ni, or Cu or an alloy of these metals is provided as an example of the base electrode film. A metal such as Sn, Au, Ni, Pt, Ag, or Pd or an alloy of these metals is provided as an example of the plating film. A thickness of the first terminal electrode 70a is, for example, 3 to 100 μm.

As illustrated in FIG. 1D, the pair of the first wire 50 and the second wire 60 have a plurality of turns 40 spaced apart from each other along the X-axis direction. One turn 40 and the other turn 40 adjacent to each other in the X-axis direction are arranged in the X-axis direction with a spacing therebetween. Namely, in the present embodiment, the pair of the first wire 50 and the second wire 60 are wound by a so-called space winding. The spacing between one turn 40 and the other turn 40 adjacent to each other in the X-axis direction is not particularly limited, but is, for example, equal to or more than one time or two times the diameter of the first wire 50 or the second wire 60. In the example illustrated in FIG. 1D, the spacing between the turns adjacent to each other in the X-axis direction is constant, but may vary.

As illustrated in FIG. 1B, the first lead-out portion 52a is led out from the winding core portion 11 toward the flange portion 12a. The second lead-out portion 62a is led out from the winding core portion 11 toward the flange portion 12a. In addition, the first lead-out portion 52b is led out from the winding core portion 11 toward the flange portion 12b. The second lead-out portion 62b is led out from the winding core portion 11 toward the flange portion 12b.

The first lead-out portion 52a includes a straight portion 53 and a rising portion 54. The second lead-out portion 62a includes an inclined portion 65 and a rising portion 64. The first lead-out portion 52b includes an inclined portion 55 and the rising portion 54. The second lead-out portion 62b includes a straight portion 63 and the rising portion 64.

The straight portion 53 of the first lead-out portion 52a passes (extends) through the recess 20a along the X-axis direction. The straight portion 53 extends along the first inner wall surface 23a. The straight portion 53 may be in contact with the first inner wall surface 23a, or may be spaced apart from the first inner wall surface 23a.

The rising portion 54 of the first lead-out portion 52a extends along the Y-axis direction, and rises from the bottom surface 200 of the recess 20a toward the first terminal electrode 70a (the substrate connecting portion 71a). Although not particularly limited, the rising portion 54 extends to an end portion of the mounting surface 13 on a negative direction side of the Y-axis. The rising portion 54 extends along the first protruding surface 25a. The rising portion 54 may be in contact with the first protruding surface 25a, or may be spaced apart from the first protruding surface 25a.

The inclined portion 65 of the second lead-out portion 62a passes through the recess 20a obliquely with respect to the X-axis direction. The inclined portion 65 is inclined in a direction away from the first lead-out portion 52a as the inclined portion 65 extends outward in the X-axis direction. The rising portion 64 of the second lead-out portion 62a extends along the Y-axis direction, and rises from the bottom surface 200 of the recess 20a toward the second terminal electrode 80a (the substrate connecting portion 81a). Although not particularly limited, the rising portion 64 extends to an end portion of the mounting surface 13 on a positive direction side of the Y-axis. The rising portion 64 extends along the second protruding surface 26a. The rising portion 64 may be in contact with the second protruding surface 26a, or may be spaced apart from the second protruding surface 26a.

The inclined portion 55 of the first lead-out portion 52b passes through the recess 20b obliquely with respect to the X-axis direction. The inclined portion 55 is inclined in a direction away from the second lead-out portion 62b as the inclined portion 55 extends outward in the X-axis direction. The rising portion 54 of the first lead-out portion 52b extends along the Y-axis direction, and rises from the bottom surface 200 of the recess 20b toward the first terminal electrode 70b (the substrate connecting portion 71b). Although not particularly limited, the rising portion 54 extends to the end portion of the mounting surface 13 on the negative direction side of the Y-axis. The rising portion 54 extends along the first protruding surface 25b. The rising portion 54 may be in contact with the first protruding surface 25b, or may be spaced apart from the first protruding surface 25b.

The straight portion 63 of the second lead-out portion 62b passes (extends) through the recess 20b along the X-axis direction. The straight portion 63 extends along the second inner wall surface 24b. The straight portion 63 may be in contact with the second inner wall surface 24b, or may be spaced apart from the second inner wall surface 24b. The rising portion 64 of the second lead-out portion 62b extends along the Y-axis direction, and rises from the bottom surface 200 of the recess 20b toward the second terminal electrode 80b (the substrate connecting portion 81b). Although not particularly limited, the rising portion 64 extends to an end portion of the mounting surface 13 on a positive direction side of the Y-axis. The rising portion 64 extends along the second protruding surface 26b. The rising portion 64 may be in contact with the second protruding surface 26b, or may be spaced apart from the second protruding surface 26b.

The rising portions 54 and 64 extend along the Y-axis direction so as to be spaced apart from each other. The rising portions 54 and 64 are located on the same straight line parallel to the Y-axis direction. However, the position of the rising portion 54 and the position of the rising portion 64 may be offset from each other along the X-axis direction.

The first lead-out portion 52a is led out from the winding core portion 11 to the first terminal electrode 70a while being in direct or indirect contact with the core 10. In more detail, the straight portion 53 is in contact with the bottom surface 200 of the recess 20a, and the rising portion 54 is in contact with the first inclined surface 21a. In addition, the second lead-out portion 62a is led out from the winding core portion 11 to the second terminal electrode 80a while being in direct or indirect contact with the core 10. In more detail, the inclined portion 65 is in contact with the bottom surface 200 of the recess 20a, and the rising portion 64 is in contact with the second inclined surface 22a.

The first lead-out portion 52b is led out from the winding core portion 11 to the first terminal electrode 70b while being in direct or indirect contact with the core 10. In more detail, the inclined portion 55 is in contact with the bottom surface 200 of the recess 20b, and the rising portion 54 is in contact with the first inclined surface 21b. In addition, the second lead-out portion 62b is led out from the winding core portion 11 to the second terminal electrode 80b while being in direct or indirect contact with the core 10. In more detail, the straight portion 63 is in contact with the bottom surface 200 of the recess 20b, and the rising portion 64 is in contact with the second inclined surface 22b.

In the example illustrated in FIG. 1A, a first connection position 56 between the first lead-out portion 52a and the first terminal electrode 70a is closer to the inner end surface 15 (FIG. 2) of the flange portion 12a than to the outer end surface 16 (FIG. 2). In addition, a second connection position 66 between the second lead-out portion 62a and the second terminal electrode 80a is closer to the inner end surface 15 of the flange portion 12a than to the outer end surface 16. In addition, the first connection position 56 between the first lead-out portion 52b and the first terminal electrode 70b is closer to the inner end surface 15 of the flange portion 12b than to the outer end surface 16. In addition, the second connection position 66 between the second lead-out portion 62b and the second terminal electrode 80b is closer to the inner end surface 15 of the flange portion 12b than to the outer end surface 16.

However, the first connection position 56 may be located at a position equidistant from the outer end surface 16 and the inner end surface 15 in the X-axis direction, or may be closer to the outer end surface 16 than to the inner end surface 15. In addition, the second connection position 66 may be located at a position equidistant from the outer end surface 16 and the inner end surface 15 in the X-axis direction, or may be closer to the outer end surface 16 than to the inner end surface 15.

A distance between the first connection position 56 and the outer end surface 16 in the X-axis direction is equal to or more than two times the diameter of the first wire 50 or the second wire 60. In addition, a distance between the second connection position 66 and the outer end surface 16 in the X-axis direction is equal to or more than two times the diameter of the first wire 50 or the second wire 60.

The first lead-out portion 52a (similarly for the first lead-out portion 52b, the second lead-out portion 62a, and the second lead-out portion 62b) is connected to the first terminal electrode 70a (the substrate connecting portion 71a) by, for example, laser welding, solder, a conductive adhesive, thermocompression bonding, ultrasonic bonding, resistance brazing, ultraviolet curable resin bonding, or the like.

The plate-shaped core 30 has a flat rectangular parallelepiped shape. The material constituting the plate-shaped core 30 is the same as the material constituting the core 10, but may be different. As illustrated in FIG. 1D, the plate-shaped core 30 is attached to the attachment surface 14 of the first flange portion 12a and the attachment surface 14 of the second flange portion 12b by, for example, an adhesive.

Next, a method for manufacturing the coil device 1 will be described. First, the core 10 including the recesses 20a and 20b, the first inclined surfaces 21a and 21b, and the second inclined surfaces 22a and 22b illustrated in FIG. 2 is prepared. A length of the core 10 in the X-axis direction is not particularly limited, but is, for example, 0.4 to 6 mm. A length of the core 10 in the Y-axis direction is not particularly limited, but is, for example, 0.2 mm to 6 mm. A length of the core 10 in the Z-axis direction is not particularly limited, but is, for example, 0.2 mm to 3 mm.

These recesses and inclined surfaces are formed by performing cutting on the flange portions of the core and hollowing out parts of the flange portions. Next, the first terminal electrode 70a and the second terminal electrode 80a are formed on the mounting surface 13 of the flange portion 12a, and the first terminal electrode 70b and the second terminal electrode 80b are formed on the mounting surface 13 of the flange portion 12b.

Next, as illustrated in FIG. 1D, the first wire 50 and the second wire 60 are wound around the outer peripheral surface 110 of the winding core portion 11 by bifilar winding and space winding. Namely, the pair of the first wire 50 and the second wire 60 is wound around outer peripheral surface 110 such that a gap is formed between the turns 40 adjacent to each other in the X-axis direction.

Next, as illustrated in FIGS. 1A and 1B, the first lead-out portion 52a (the straight portion 53) is led out from the winding core portion 11 toward the recess 20a along the first inner wall surface 23a. In addition, the first lead-out portion 52a (the rising portion 54) rises obliquely from the recess 20a to the first terminal electrode 70a along the first inclined surface 21a and the first protruding surface 25a.

In addition, the second lead-out portion 62a (the inclined portion 65) is led out from the winding core portion 11 toward the recess 20a obliquely with respect to the X-axis direction. In addition, the second lead-out portion 62a (the rising portion 64) rises obliquely from the recess 20a to the second terminal electrode 80a along the second inclined surface 22a and the second protruding surface 26a.

In addition, the second lead-out portion 52b (the inclined portion 54) is led out from the winding core portion 11 toward the recess 20b obliquely with respect to the X-axis direction. In addition, the first lead-out portion 52b (the rising portion 54) rises from the recess 20b to the first terminal electrode 70b along the first inclined surface 21b and the first protruding surface 25b.

In addition, the second lead-out portion 62b (the straight portion 63) is led out from the winding core portion 11 toward the recess 20b along the second inner wall surface 24b. In addition, the second lead-out portion 62b (the rising portion 64) rises from the recess 20b to the second terminal electrode 80b along the second inclined surface 22b and the second protruding surface 26b.

Next, the rising portion 54 of the first lead-out portion 52a is connected to the substrate connecting portion 71a of the first terminal electrode 70a by, for example, thermocompression bonding. Similarly, the rising portion 64 of the second lead-out portion 62a is connected to the substrate connecting portion 81a of the second terminal electrode 80a. Similarly, the rising portion 54 of the first lead-out portion 52b is connected to the substrate connecting portion 71b of the first terminal electrode 70b. Similarly, the rising portion 64 of the second lead-out portion 62b is connected to the substrate connecting portion 81b of the second terminal electrode 80b.

Next, as illustrated in FIG. 1D, the plate-shaped core 30 is attached to the attachment surface 14 of the flange portion 12a and the attachment surface 14 of the flange portion 12b. For example, the plate-shaped core 30 may be adhered to the attachment surface 14 by an adhesive. The coil device 1 can be manufactured as described above.

As illustrated in FIG. 1A, in the coil device 1 of the present embodiment, the flange portion 12a includes the recess 20a recessed from the mounting surface 13 between the first terminal electrode 70a and the second terminal electrode 80a. Therefore, at least a part of a path that diffuses the magnetic flux toward the mounting surface 13 side of the flange portion 12a is blocked by the recess 20a, so that the magnetic flux is less likely to diffuse to the mounting surface 13 side. Accordingly, leakage magnetic flux is reduced, and the amount of magnetic flux passing through the path connecting the winding core portion 11, the flange portion 12a, the plate-shaped core 30, and the flange portion 12b in the shortest distance is increased. Therefore, the insertion loss of the coil device 1 caused by leakage magnetic flux can be reduced. In addition, the bottom surface 200 of the recess 20a is flush with the outer peripheral surface 110 of the winding core portion 11. Therefore, no step is formed between the bottom surface 200 of the recess 20a and the outer peripheral surface 110 of the winding core portion 11, and the concentration of magnetic flux on the step, which is a cause of insertion loss, can be avoided.

In addition, as illustrated in FIG. 1D, the second wire 60 is wound around the winding core portion 11 so as to form a pair with the first wire 50. Furthermore, the pair of the first wire 50 and the second wire 60 have the plurality of turns 40 spaced apart from each other along the X-axis direction. Therefore, the coupling between the first wire 50 and the second wire 60 is improved, and leakage magnetic flux is reduced. In addition, the stray capacitance between the turns 40 adjacent to each other along the X-axis direction is reduced. Accordingly, the insertion loss of the coil device 1 caused by leakage magnetic flux can be further reduced.

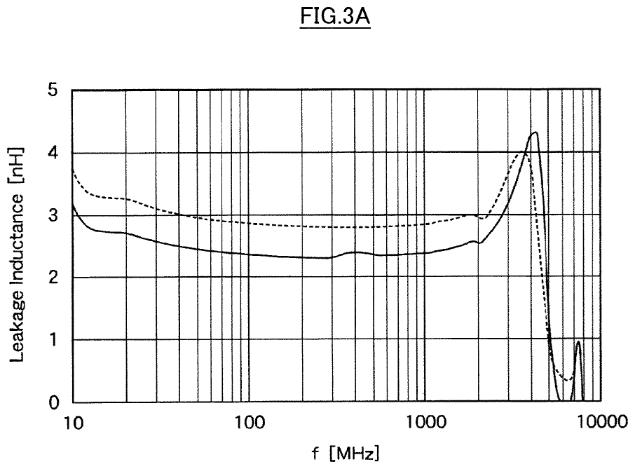

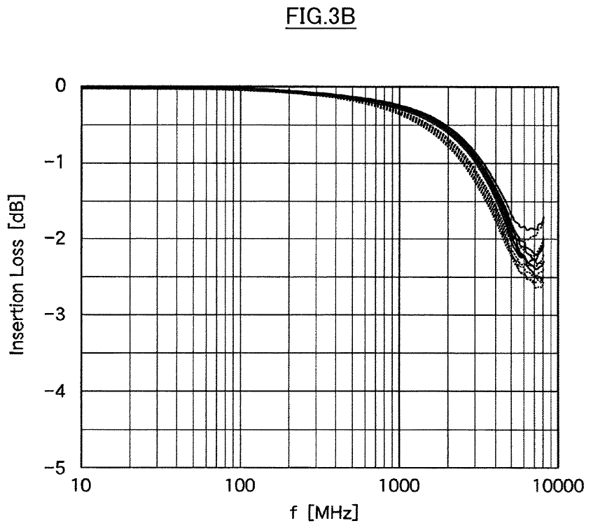

In FIG. 3A, a solid line on the graph illustrates a simulation result of the frequency characteristics of leakage inductance of the coil device 1 of the present embodiment, and a dashed line on the graph illustrates a simulation result of the frequency characteristics of leakage inductance of a conventional coil device. The conventional coil device differs from the coil device 1 of the present embodiment in that the conventional coil device does not include the recesses 20a and 20b. As can be seen from FIG. 3A, in the coil device 1 of the present embodiment, the leakage inductance is smaller at least in a frequency band of 3500 MHz or less compared to that of the conventional coil device.

In addition, in FIG. 3B, a solid line on the graph illustrates a simulation result of the frequency characteristics of insertion loss of the coil device 1 of the present embodiment, and a dashed line on the graph illustrates a simulation result of the frequency characteristics of insertion loss of the conventional coil device. The conventional coil device differs from the coil device 1 of the present embodiment in that the conventional coil device does not include the recesses 20a and 20b. As can be seen from FIG. 3B, in the coil device 1 of the present embodiment, the insertion loss is smaller at least in a frequency band of 4000 MHz or less compared to that of the conventional coil device.

In addition, as illustrated in FIG. 2, the flange portion 12a has the inner end surface 15 connected to the winding core portion 11, and the outer end surface 16 opposite to the inner end surface 15 along the X-axis direction. Furthermore, the recess 20a extends from the inner end surface 15 to the outer end surface 16 along the X-axis direction. Therefore, the recess 20a blocks at least a part of the path, which diffuses the magnetic flux toward the mounting surface 13 side of the flange portion 12a, in a wide range between the first terminal electrode 70a and the second terminal electrode 80a. Accordingly, leakage magnetic flux can be effectively reduced.

In addition, as illustrated in FIG. 1A, the first wire 50 includes the first lead-out portion 52a led out from the winding core portion 11 toward the flange portion 12a. In addition, the second wire 60 includes the second lead-out portion 62a led out from the winding core portion 11 toward the flange portion 12a. Furthermore, the first lead-out portion 52a is led out from the winding core portion 11 to the first terminal electrode 70a while being in contact with the core 10. In addition, the second lead-out portion 62a is led out from the winding core portion 11 to the second terminal electrode 80a while being in contact with the core 10. Therefore, the first lead-out portion 52a and the second lead-out portion 62a are less likely to be wired in the air, so that disconnection of the first lead-out portion 52a and the second lead-out portion 62a can be prevented.

In addition, as illustrated in FIG. 1B, the first lead-out portion 52a includes the straight portion 53 passing through the recess 20a along the X-axis direction, and the rising portion 54 that extends along the Y-axis direction and that rises from the bottom surface 200 of the recess 20a toward the first terminal electrode 70a. In addition, the second lead-out portion 62a includes the inclined portion 65 passing through the recess 20a obliquely with respect to the X-axis direction, and the rising portion 64 that extends along the Y-axis direction and that rises from the bottom surface 200 of the recess 20a toward the second terminal electrode 80a. Therefore, the first lead-out portion 52a (the straight portion 53) can be led out from the winding core portion 11 to a predetermined position on the recess 20a (the rising position of the first lead-out portion 52a) in the shortest distance along the X-axis direction. In addition, the second lead-out portion 62a (the inclined portion 65) can be led out from the winding core portion 11 to a predetermined position on the recess 20a (the rising position of the second lead-out portion 62a) in the shortest distance while avoiding bending of the second lead-out portion 62a.

In addition, the flange portion 12a has the first inclined surface 21a and the second inclined surface 22a. Furthermore, the first inclined surface 21a is inclined from the bottom surface 200 of the recess 20a toward the mounting surface 13 on the one side in the Y-axis direction. In addition, the second inclined surface 22a is inclined from the bottom surface 200 of the recess 20a toward the mounting surface 13 on the other side in the Y-axis direction. Therefore, the first lead-out portion 52a can be led out to the mounting surface 13 along the first inclined surface 21a while suppressing excessive bending of the first lead-out portion 52a. In addition, the second lead-out portion 62a can be led out to the mounting surface 13 along the second inclined surface 22a while suppressing excessive bending of the second lead-out portion 62a. Accordingly, disconnection of the first lead-out portion 52a and the second lead-out portion 62a caused by bending can be prevented.

In addition, as illustrated in FIG. 2, the flange portion 12a has the first inner wall surface 23a and the second inner wall surface 24a. In addition, the first inner wall surface 23a rises perpendicularly from the bottom surface 200 of the recess 20a toward the mounting surface 13 on the one side in the Y-axis direction. In addition, the second inner wall surface 24a rises perpendicularly from the bottom surface 200 of the recess 20a toward the mounting surface 13 on the other side in the Y-axis direction. Furthermore, in the X-axis direction, the first inner wall surface 23a is located on the inner side of the flange portion 12a, and the first inclined surface 21a is located on the outer side of the flange portion 12a. In addition, in the X-axis direction, the second inner wall surface 24a is located on an inner side of the flange portion 12a, and the second inclined surface 22a is located on an outer side of the flange portion 12a. Therefore, as illustrated in FIG. 1B, the first lead-out portion 52a can be led out to the first inclined surface 21a along the first inner wall surface 23a, and can be further led out to the mounting surface 13 along the first inclined surface 21a. Alternatively, the second lead-out portion 62b can be led out to the second inclined surface 22b along the second inner wall surface 24b, and can be further led out to the mounting surface 13 along the second inclined surface 22b. Accordingly, a variation in the lead-out positions of the first lead-out portion 52a and the second lead-out portion 62b can be prevented.

In addition, the flange portion 12a has the inner end surface 15 connected to the winding core portion 11, and the outer end surface 16 opposite to the inner end surface 15 along the X-axis direction. Furthermore, as illustrated in FIG. 1A, the first connection position 56 between the first lead-out portion 52a and the first terminal electrode 70a is closer to the inner end surface 15 than to the outer end surface 16. In addition, the second connection position 66 between the second lead-out portion 62a and the second terminal electrode 80a is closer to the inner end surface 15 than to the outer end surface 16. Therefore, in the first terminal electrode 70a, a connecting surface with the mounting substrate can be ensured between the first connection position 56 and the outer end surface 16. In addition, in the second terminal electrode 80a, a connecting surface with the mounting substrate can be ensured between the second connection position 66 and the outer end surface 16. Since these connecting surfaces have good adhesiveness for solder, a conductive adhesive, or the like, the mounting strength between the coil device 1 and the mounting substrate can be increased.

### Second Embodiment

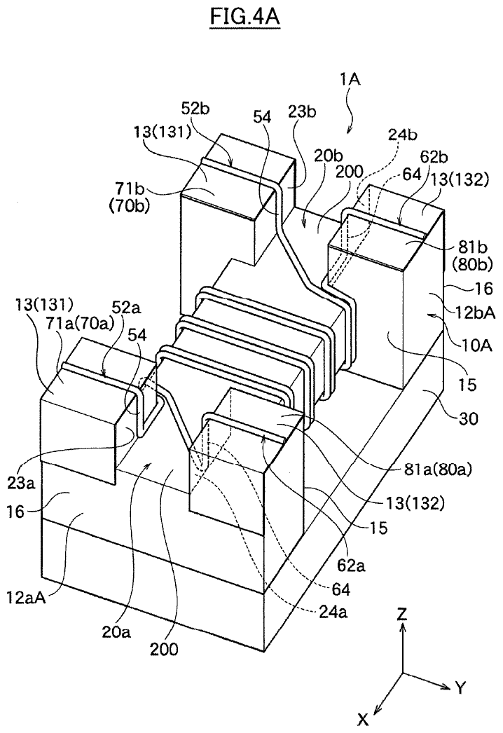

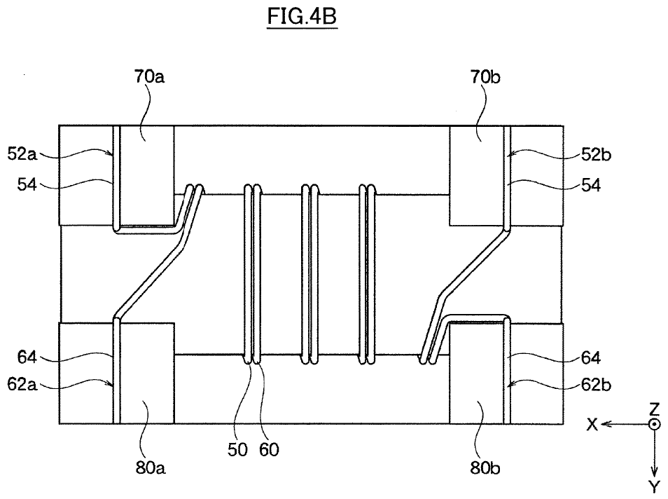

A coil device 1A of a second embodiment illustrated in FIG. 4A has a configuration similar to that of the coil device 1 of the first embodiment, except for the following points. Portions that overlap with the coil device 1 of the first embodiment are denoted by the same reference numerals, and detailed descriptions thereof will be omitted.

The coil device 1A includes a core 10A. The core 10A includes flange portions 12aA and 12bA. The flange portion 12aA differs from the flange portion 12a of the first embodiment in that the flange portion 12aA does not have the first inclined surface 21a and the second inclined surface 22a. The flange portion 12bA differs from the flange portion 12b of the first embodiment in that the flange portion 12bA does not have the first inclined surface 21b and the second inclined surface 22b.

The first inner wall surface 23a extends continuously from the inner end surface 15 of the flange portion 12aA to the outer end surface 16 along the X-axis direction. In addition, the second inner wall surface 24a extends continuously from the inner end surface 15 of the flange portion 12aA to the outer end surface 16 along the X-axis direction.

In addition, the first inner wall surface 23b extends continuously from the inner end surface 15 of the flange portion 12bA to the outer end surface 16 along the X-axis direction. In addition, the second inner wall surface 24b extends continuously from the inner end surface 15 of the flange portion 12bA to the outer end surface 16 along the X-axis direction.

The rising portion 54 of the first lead-out portion 52a rises from the bottom surface 200 of the recess 20a while being in contact with the first inner wall surface 23a. The rising portion 54 rises perpendicularly to the bottom surface 200 along the first inner wall surface 23a. In addition, the rising portion 54 is led out along the mounting surface 13 (the first region 131), and is connected to the first terminal electrode 70a (the substrate connecting portion 71a). The rising portion 54 extends parallel to the Z-axis, but may be inclined in an XZ plane with respect to the Z-axis.

The rising portion 64 of the second lead-out portion 62a rises from the bottom surface 200 of the recess 20a while being in contact with the second inner wall surface 24a. The rising portion 64 rises perpendicularly to the bottom surface 200 along the second inner wall surface 24a. In addition, the rising portion 64 is led out along the mounting surface 13 (the second region 132), and is connected to the second terminal electrode 80a (the substrate connecting portion 81a). The rising portion 64 extends parallel to the Z-axis, but may be inclined in an XZ plane with respect to the Z-axis.

The rising portion 54 of the first lead-out portion 52b rises from the bottom surface 200 of the recess 20b while being in contact with the first inner wall surface 23b. The rising portion 54 rises perpendicularly to the bottom surface 200 along the first inner wall surface 23b. In addition, the rising portion 54 is led out along the mounting surface 13 (the first region 131), and is connected to the first terminal electrode 70b (the substrate connecting portion 71b). The rising portion 54 extends parallel to the Z-axis, but may be inclined in an XZ plane with respect to the Z-axis.

The rising portion 64 of the second lead-out portion 62b rises from the bottom surface 200 of the recess 20b while being in contact with the second inner wall surface 24b. The rising portion 64 rises perpendicularly to the bottom surface 200 along the second inner wall surface 24b. In addition, the rising portion 64 is led out along the mounting surface 13 (the second region 132), and is connected to the second terminal electrode 80b (the substrate connecting portion 81b). The rising portion 64 extends parallel to the Z-axis, but may be inclined in an XZ plane with respect to the Z-axis.

As illustrated in FIG. 4B, the rising portion 54 and the rising portion 64 extend along the Y-axis direction so as to be spaced apart from each other. The rising portion 54 and the rising portion 64 are located on the same straight line parallel to the Y-axis direction. However, the position of the rising portion 54 and the position of the rising portion 64 may be offset from each other along the X-axis direction.

In the present embodiment as well, effects similar to those of the first embodiment can be obtained. In addition, in the present embodiment, the flange portion 12a does not have the first inclined surface 21a and the second inclined surface 22a (FIG. 2), and a part of the mounting surface 13 is not cut by the first inclined surface 21a and the second inclined surface 22a. Therefore, the area of the mounting surface 13 (the first region 131 and the second region 132) is increased accordingly, and the areas of the first terminal electrode 70a and the second terminal electrode 80a are increased accordingly. Accordingly, the mounting strength between the coil device 1A and the mounting substrate (not illustrated) can be increased.

### Third Embodiment

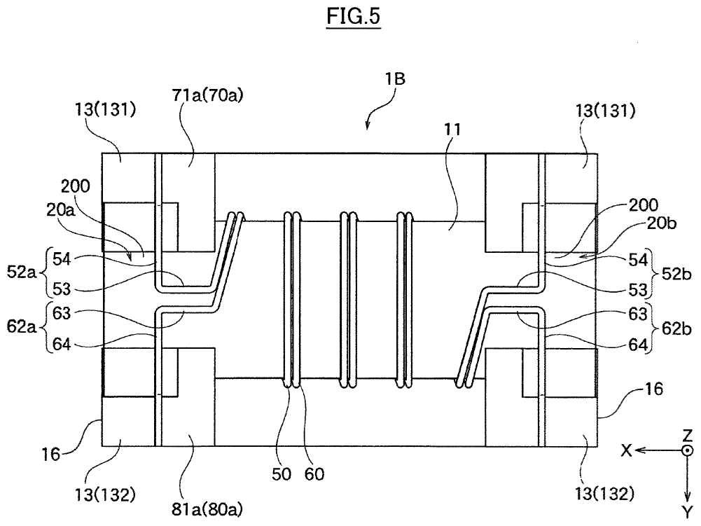

A coil device 1B of a third embodiment illustrated in FIG. 5 has a configuration similar to that of the coil device 1 of the first embodiment, except for the following points. Portions that overlap with the coil device 1 of the first embodiment are denoted by the same reference numerals, and detailed descriptions thereof will be omitted.

As illustrated in FIG. 5, in the present embodiment, the first lead-out portion 52a includes the straight portion 53 passing through the recess 20a along the X-axis direction. In addition, the first lead-out portion 52a includes the rising portion 54 that extends along the Y-axis direction, and that rises from the bottom surface 200 of the recess 20a toward the mounting surface 13 (the first region 131). In the example illustrated in FIG. 5, the straight portion 53 is orthogonal to the rising portion 54.

In addition, the second lead-out portion 62a includes the straight portion 63 passing through the recess 20a along the X-axis direction. In addition, the second lead-out portion 62a includes the rising portion 64 that extends along the Y-axis direction, and that rises from the bottom surface 200 of the recess 20a toward the mounting surface 13 (the second region 132). In the example illustrated in FIG. 5, the straight portion 63 is orthogonal to the rising portion 64.

In addition, the first lead-out portion 52b includes the straight portion 53 passing through the recess 20b along the X-axis direction. In addition, the first lead-out portion 52b includes the rising portion 54 that extends along the Y-axis direction, and that rises from the bottom surface 200 of the recess 20b toward the mounting surface 13 (the first region 131). In the example illustrated in FIG. 5, the straight portion 53 is orthogonal to the rising portion 54.

In addition, the second lead-out portion 62b includes the straight portion 63 passing through the recess 20b along the X-axis direction. In addition, the second lead-out portion 62b includes the rising portion 64 that extends along the Y-axis direction, and that rises from the bottom surface 200 of the recess 20b toward the mounting surface 13 (the second region 132). In the example illustrated in FIG. 5, the straight portion 63 is orthogonal to the rising portion 64.

In the example illustrated in FIG. 5, the straight portion 53 and the straight portion 63 extend parallel to each other along the X-axis direction. A spacing between the straight portion 53 and the straight portion 63 in the Y-axis direction is not particularly limited, but is equivalent to or more than the diameter of the first wire 50 or the second wire 60. However, the straight portion 53 and the straight portion 63 may be in contact with each other.

In the present embodiment as well, effects similar to those of the first embodiment can be obtained. In addition, in the present embodiment, as described above, both the first lead-out portion 52a and the second lead-out portion 62a includes straight portions (the straight portions 53 and 63). Therefore, the first lead-out portion 52a and the second lead-out portion 62a are led out from the winding core portion 11 to the mounting surface 13 so as to be symmetrical with respect to the X-axis direction. Accordingly, the lengths of the first lead-out portion 52a and the second lead-out portion 62a can be similar to each other, so that the insertion loss of the coil device 1B can be reduced. In addition, the first rising portion 54 and the second rising portion 64 are led out from the bottom surface 200 of the recess 20a to the mounting surface 13 in parallel to the outer end surface 16 of the flange portion 12a so as to extend toward the outer end surface 16. Therefore, the first lead-out portion 52a can be connected to the first terminal electrode 70a (the substrate connecting portion 71a) at a position away from the outer end surface 16, and a mounting area for the first terminal electrode 70a can be ensured. In addition, the second lead-out portion 62a can be connected to the second terminal electrode 80a (the substrate connecting portion 81a) at a position away from the outer end surface 16, and a mounting area for the second terminal electrode 80a can be ensured.

### Fourth Embodiment

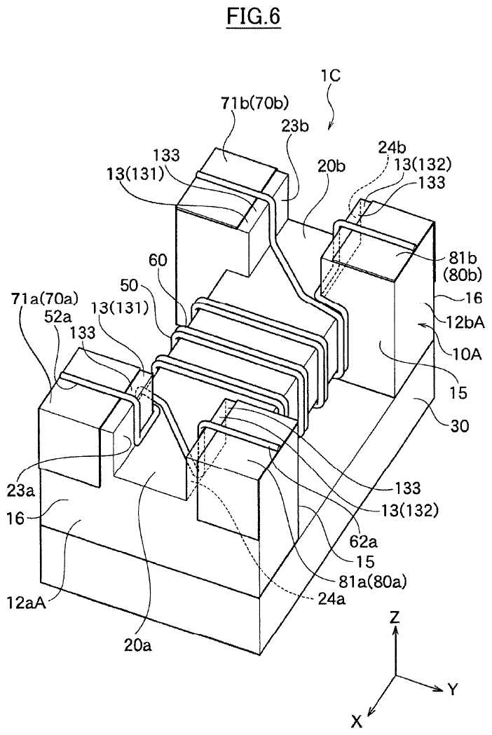

A coil device 1C of a fourth embodiment illustrated in FIG. 6 has a configuration similar to that of the coil device 1A of the second embodiment, except for the following points. Portions that overlap with the coil device 1A of the second embodiment are denoted by the same reference numerals, and detailed descriptions thereof will be omitted.

As illustrated in FIG. 6, in the flange portion 12aA, the first region 131 of the mounting surface 13 includes an exposed portion 133 located between the first terminal electrode 70a (the substrate connecting portion 71a) and the recess 20a. In addition, the second region 132 of the mounting surface 13 includes the exposed portion 133 located between the second terminal electrode 80a (the substrate connecting portion 81a) and the recess 20a. At the exposed portion 133 of the first region 131, the mounting surface 13 is not covered by the first terminal electrode 70a, and is exposed to the outside. At the exposed portion 133 of the second region 132, the mounting surface 13 is not covered by the second terminal electrode 80a, and is exposed to the outside.

In addition, in the flange portion 12bA, the first region 131 of the mounting surface 13 includes the exposed portion 133 located between the first terminal electrode 70b (the substrate connecting portion 71b) and the recess 20b. In addition, the second region 132 of the mounting surface 13 includes the exposed portion 133 located between the second terminal electrode 80b (the substrate connecting portion 81b) and the recess 20b. At the exposed portion 133 of the first region 131, the mounting surface 13 is not covered by the first terminal electrode 70b, and is exposed to the outside. At the exposed portion 133 of the second region 132, the mounting surface 13 is not covered by the second terminal electrode 80b, and is exposed to the outside.

The exposed portion 133 extends from the inner end surface 15 to the outer end surface 16 along the X-axis. A width of the exposed portion 133 in the Y-axis direction is narrower than a width of the first terminal electrode 70a (the substrate connecting portion 71a) in the Y-axis direction. The width of the exposed portion 133 in the Y-axis direction is not particularly limited, but is less than ½ or ⅓ of the width of the first terminal electrode 70a (the substrate connecting portion 71a) in the Y-axis direction. The width of the exposed portion 133 in the Y-axis direction is constant along the X-axis direction, but may vary.

In the present embodiment as well, effects similar to those of the second embodiment can be obtained. In addition, in the present embodiment, the first region 131 includes the exposed portion 133 located between the first terminal electrode 70a and the recess 20a. In addition, the second region 132 includes the exposed portion 133 located between the second terminal electrode 80a and the recess 20a. Furthermore, the mounting surface 13 is exposed at these exposed portions 133. Since the first terminal electrode 70a is not formed on the exposed portion 133 of the first region 131, the stray capacitance between the first wire 50 (the first lead-out portion 52a) and the first terminal electrode 70a is reduced, so that the insertion loss of the coil device 1C can be reduced. In addition, since the second terminal electrode 80a is not formed on the exposed portion 133 of the second region 132, the stray capacitance between the second wire 60 (the second lead-out portion 62a) and the second terminal electrode 80a is reduced, so that the insertion loss of the coil device 1C can be reduced.

The present invention is not limited to the above-described embodiments, and can be modified in various modes without departing from the scope of the present invention.

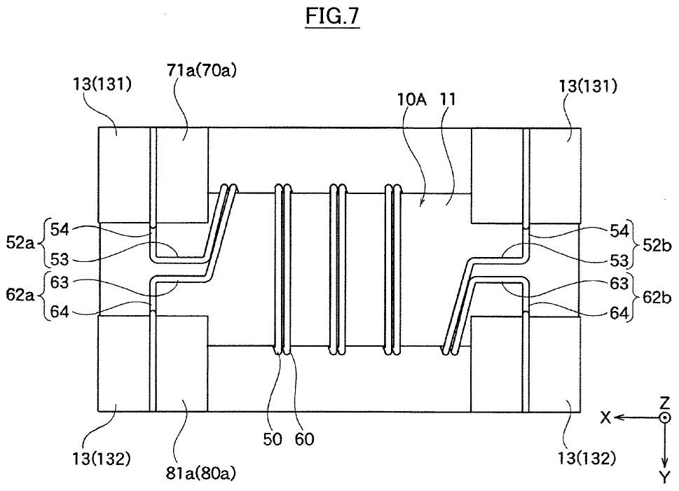

As illustrated in FIG. 7, the technique of the third embodiment may be applied to the second embodiment. Namely, both the first lead-out portion 52a and the second lead-out portion 62a may include straight portions (the straight portions 53 and 63). In addition, both the first lead-out portion 52b and the second lead-out portion 62b may include straight portions (the straight portions 53 and 63).

In each of the above-described embodiments, the first terminal electrode 70a (similarly for the first terminal electrode 70b, the second terminal electrode 80a, and the second terminal electrode 80b) may be configured as a terminal fitting obtained by bending and/or cutting a metal plate.

In each of the above-described embodiments, only one of the first inclined surface 21a and the second inclined surface 22a may be formed in the first flange portion 12a. In addition, only one of the first inclined surface 21b and the second inclined surface 22b may be formed in the first flange portion 12b.

In the second to fourth embodiments illustrated in FIGS. 4B, 5, 6, and 7, the connection position between the first lead-out portion 52a and the first terminal electrode 70a is located at a position equidistant from the outer end surface 16 and the inner end surface 15, but may be closer to the inner end surface 15 than to the outer end surface 16. In addition, the connection position between the second lead-out portion 62a and the second terminal electrode 80a is located at a position equidistant from the outer end surface 16 and the inner end surface 15, but may be closer to the inner end surface 15 than to the outer end surface 16. In addition, the connection position between the first lead-out portion 52b and the first terminal electrode 70b is located at a position equidistant from the outer end surface 16 and the inner end surface 15, but may be closer to the inner end surface 15 than to the outer end surface 16. In addition, the connection position between the second lead-out portion 62b and the second terminal electrode 80b is located at a position equidistant from the outer end surface 16 and the inner end surface 15, but may be closer to the inner end surface 15 than to the outer end surface 16.

### EXPLANATIONS OF LETTERS OR NUMERALS

1, 1A to 1C COIL DEVICE
10, 10A CORE
11 CORE PORTION
110 OUTER PERIPHERAL SURFACE
111 UPPER SURFACE
12a, 12b, 12aA, 12bA FLANGE PORTION
13 MOUNTING SURFACE
131 FIRST REGION
132 SECOND REGION
133 EXPOSED PORTION
14 ATTACHMENT SURFACE
15 INNER END SURFACE
16 OUTER END SURFACE
17 FIRST SIDE SURFACE
18 SECOND SIDE SURFACE
20a, 20b RECESS
200 BOTTOM SURFACE
21a, 21b FIRST INCLINED SURFACE
22a, 22b SECOND INCLINED SURFACE
23a, 23b FIRST INNER WALL SURFACE
24a, 24b SECOND INNER WALL SURFACE
25a, 25b FIRST PROTRUDING SURFACE
26a, 26b SECOND PROTRUDING SURFACE
30 PLATE-SHAPED CORE
40 TURN
50 FIRST WIRE
51 WINDING PORTION
52a, 52b LEAD-OUT PORTION
53 STRAIGHT PORTION
54 RISING PORTION
55 INCLINED PORTION
56 CONNECTION POSITION
60 SECOND WIRE
61 WINDING PORTION
62a, 62b LEAD-OUT PORTION
63 STRAIGHT PORTION
64 RISING PORTION
65 INCLINED PORTION
66 CONNECTION POSITION
70a, 70b, 80a, 80b TERMINAL ELECTRODE
71a, 71b, 81a, 81b SUBSTRATE CONNECTING PORTION
72a, 72b, 82a, 82b SIDE PORTION

What is claimed is:

1. A coil device, comprising:
a core including a winding core portion and a flange portion formed at an end portion of the winding core portion in an axial direction;
a plate-shaped core attached to the core;
a first wire wound around the winding core portion;
a second wire wound around the winding core portion so as to form a pair with the first wire;
a first terminal electrode provided on at least a mounting surface of the flange portion; and
a second terminal electrode provided on at least the mounting surface, and spaced apart from the first terminal electrode,
wherein the flange portion includes a recess recessed from the mounting surface between the first terminal electrode and the second terminal electrode,
a bottom surface of the recess is flush with an outer peripheral surface of the winding core portion, and
the pair of the first wire and the second wire have a plurality of turns spaced apart from each other along the axial direction.

2. The coil device according to claim 1,
wherein the flange portion has an inner end surface connected to the winding core portion, and an outer end surface opposite to the inner end surface along the axial direction, and
the recess extends from the inner end surface to the outer end surface along the axial direction.

3. The coil device according to claim 1,
wherein the first wire includes a first lead-out portion led out from the winding core portion toward the flange portion,
the second wire includes a second lead-out portion led out from the winding core portion toward the flange portion,
the first lead-out portion is led out from the winding core portion to the first terminal electrode while being in contact with the core, and
the second lead-out portion is led out from the winding core portion to the second terminal electrode while being in contact with the core.

4. The coil device according to claim 3,
wherein the first lead-out portion includes a first straight portion passing through the recess along the axial direction, and a first rising portion that extends along a direction perpendicular to the axial direction in a plan view, and that rises from the bottom surface of the recess toward the mounting surface, and
the second lead-out portion includes a second straight portion passing through the recess along the axial direction, and a second rising portion that extends along the direction perpendicular to the axial direction in a planar view, and that rises from the bottom surface of the recess toward the mounting surface.

5. The coil device according to claim 3,
wherein the first lead-out portion includes a straight portion passing through the recess along the axial direction, and a first rising portion that extends along a direction perpendicular to the axial direction in a plan view, and that rises from the bottom surface of the recess toward the first terminal electrode, and
the second lead-out portion includes an inclined portion passing through the recess obliquely with respect to the axial direction, and a second rising portion that extends along the direction perpendicular to the axial direction in a plan view, and that rises from the bottom surface of the recess toward the second terminal electrode.

6. The coil device according to claim 1,
wherein the flange portion has a first inclined surface and a second inclined surface,
the first inclined surface is inclined from the bottom surface of the recess toward the mounting surface on one side in a direction perpendicular to the axial direction in a plan view, and
the second inclined surface is inclined from the bottom surface of the recess toward the mounting surface on the other side in the direction perpendicular to the axial direction in a plan view.

7. The coil device according to claim 6,
wherein the flange portion has a first inner wall surface and a second inner wall surface,
the first inner wall surface rises perpendicularly from the bottom surface of the recess toward the mounting surface on the one side in the direction perpendicular to the axial direction in a plan view,
the second inner wall surface rises perpendicularly from the bottom surface of the recess toward the mounting surface on the other side in the direction perpendicular to the axial direction in a plan view,
in the axial direction, the first inner wall surface is located on an inner side of the flange portion, and the first inclined surface is located on an outer side of the flange portion, and
in the axial direction, the second inner wall surface is located on the inner side of the flange portion, and the second inclined surface is located on the outer side of the flange portion.

8. The coil device according to claim 3,
wherein the flange portion has an inner end surface connected to the winding core portion, and an outer end surface opposite to the inner end surface along the axial direction,
a first connection position between the first lead-out portion and the first terminal electrode is closer to the inner end surface than to the outer end surface, and
a second connection position between the second lead-out portion and the second terminal electrode is closer to the inner end surface than to the outer end surface.

9. The coil device according to claim 1,
wherein the mounting surface includes a first region where the first terminal electrode is provided, and a second region where the second terminal electrode is provided,
the recess is located between the first region and the second region,
the first region includes a first exposed portion located between the first terminal electrode and the recess,
the second region includes a second exposed portion located between the second terminal electrode and the recess, and
the mounting surface is exposed at the first exposed portion and the second exposed portion.
